(19) United States
(12) Patent Application Publication
(10) Pub. No.: US 2014/0360665 A1
(43) Pub. Date: Dec. 11, 2014

(54) REFLECTOR MANUFACTURED USING MULTIPLE USE PRECISION EXTRACTABLE TOOLING

(71) Applicant: COMPOSITE TECHNOLOGY DEVELOPMENT, INC., Lafayette, CO (US)

(72) Inventors: Michael Tupper, Lafayette, CO (US); Robert Taylor, Superior, CO (US); Dana Turse, Broomfield, CO (US); Rory Barrett, Erie, CO (US); Larry G. Adams, Thornton, CO (US)

(21) Appl. No.: 14/365,969

(22) PCT Filed: Dec. 19, 2012
(86) PCT No.: PCT/US12/70490

§ 371 Date: Jun. 16, 2014

Related U.S. Application Data
(63) Continuation of application No. 13/330,232, filed on Dec. 19, 2011.
(60) Provisional application No. 61/599,257, filed on Feb. 15, 2012.
(60) Provisional application No. 61/596,061, filed on Feb. 7, 2012.

(51) Int. Cl. B32B 37/10; B32B 37/14

(52) U.S. Cl. CPC B32B 37/10; B32B 37/14
USPC 156/285; 156/349; 156/307.1

(57) ABSTRACT

A unitary reflector system and methods for forming that include a reflector and support structure. These two structures can form a single unitary structure. Such a reflector system can be constructed from composite laminate materials that are laid up or formed in during a single manufacturing process. The composite support structure can be formed on the back of the reflector using standard laminate techniques. An extractable tool, can include a rigid core, one or more foam blocks, which may be shape a memory polymer foam, an elastic membrane, and a nozzle. The foam blocks can be shaped to provide a mold of the composite structure being manufactured. This mold may require the extractable tool to be trapped by the composite structure after manufacture. Use of the foams can allow the extractable tool to shrink in at least one dimension in order to extract the tool from the trapped configuration. E

### CROSS-REFERENCE TO RELATED APPLICATION

This PCT Application claims priority to U.S. patent application Ser. No. 13/330,232, filed Dec. 19, 2011, entitled “MULTIPLE USE PRECISION EXTRACTABLE TOOLING”, and U.S. Provisional Application No. 61/596,061, filed Feb. 7, 2012, entitled “RAPID CYCLE MULTIPLE USE PRECISION EXTRACTABLE TOOLING”, and U.S. Provisional Application No. 61/599,257, filed Feb. 15, 2012, entitled “REFLECTOR MANUFACTURED USING MULTIPLE USE PRECISION EXTRACTABLE TOOLING”, the disclosures of which are incorporated by reference in their entirety herein for all purposes.

### BACKGROUND

Composite materials hold great promise to provide weight and energy savings for high performance applications in aircraft structures, wind turbine and tidal turbine blades, marine propeller blades, spacecraft structures, and automobiles. These applications, and many others, require stiff, mass minimized structures that are optimized with complex skins, stringers, spars and ribs to provide global stiffness, local stiffness, and sufficient strength at the lowest reasonable cost. Reflectors are one such application. These highly optimized designs are trending towards the co-curing of multiple complex components at the same time to produce a “unitized” composite structure. The use of unitized structures allows for very large complex composite structures to be fabricated in a single manufacturing process. This practice has many advantages, including the reduction in the number of adhesive bonding steps, stronger bonds, a significant reduction in part-count, and a decrease in post-cure attachment of parts. Many designs can involve multiple “trapped” shapes, or areas in which a mold is effectively trapped within the part after cure. The tooling required for this type of fabrication has become increasingly complex and costly, such that tooling is the single highest cost item in many composite designs.

### BRIEF SUMMARY

Embodiments of the invention are directed toward extractable tooling devices for composite structure manufacturing. An extractable tool, according to some embodiments of the invention, can include a rigid core, one or more foam blocks, which may be shape a memory polymer foam, an elastic membrane, and a nozzle. The foam blocks can be shaped to provide a mold of the composite structure being manufactured. This mold may require the extractable tool to be trapped by the composite structure after manufacture. Use of the foams can allow the extractable tool to shrink in at least one dimension in order to extract the tool from the trapped configuration. Furthermore, the invention can allow for ‘out of autoclave curing’ of composite structures, as the pressure applied internally, within the tool during cure can be used to provide for appropriate consolidation of the reinforcing fibers within the composite laminate, much in the manner that pressure in an autoclave is used to consolidate a composite laminate.

Embodiments of the invention are also directed toward unitary reflectors. A unitary reflector system can include the reflector and all or portions of the support structure. In some embodiments, the reflector and the support structure can be manufactured from the same or substantially similar composite materials and/or manufactured in a single manufacturing process.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE DRAWINGS

Illustrative embodiments of the present invention are described in detail below with reference to the following figures.

FIG. 1 shows an example of an extractable tool according to some embodiments of the invention.

FIGS. 2A, 2B and 2C show side views of composite layers being laid up conformally with an extractable tool according to some embodiments of the invention.

FIGS. 3A, 3B, 3C, and 3D show photographs of an extractable tool being extracted from a composite structure according to some embodiments of the invention.

FIGS. 4A, 4B and 4C show three extractable tools being used to lay-up two composite I-beam structures according to some embodiments of the invention.

FIG. 5 is a flowchart of a process for using an extractable tool according to some embodiments of the invention.

FIGS. 6A-6C show various views of a reflector and/or support structure according to some embodiments of the invention.

FIGS. 7A-7C show various views of a reflector and/or support structure according to some embodiments of the invention.

FIGS. 8A-8C show various views of a reflector and/or support structure according to some embodiments of the invention.

FIGS. 9A and 9B show two extractable tools being used to lay-up two composite I-beam support structures on a reflector according to some embodiments of the invention.

FIG. 10 shows a side view of a portion of a reflector with an I-beam support structure according to some embodiments of the invention.

FIG. 11 is a flowchart of a process for forming a reflector system using an extractable tool according to some embodiments of the invention.

FIG. 12 is a flowchart of another process for using an extractable tool according to some embodiments of the invention.

FIG. 13 is yet another flowchart of a process for using an extractable tool according to some embodiments of the invention.

FIGS. 14A-14D show an extractable tool in use with a mold according to some embodiments of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Like numerals within the drawings and mentioned herein represent substantially identical structural elements. Each example is provided by way of explanation, and not as a limitation. For instance, features illustrated or described as part of one embodiment may be used on another embodiment to yield a further embodiment. Thus, it is intended that this disclosure includes modifications and variations.

Generally speaking embodiments of the invention include devices, apparatus, and methods for tooling composite reflectors with trapped tooling conditions. Reflectors with various reflector shapes and various support structure configurations can be fabricated. These reflectors and support structures can be fabricated using the same or similar materials and/or can be fabricated during a single fabrication process. Because the reflector and the support structure is fabricated from the same materials and/or during the same process they can have improved temperature responses.

Foam Tooling

In some embodiments, a Multiple Use Precision Extractable Tooling (MUPET) technology is disclosed for fabricating reflectors that use foams; for example, shape memory polymer (SMP) foams. SMP foams can include, for example, TEMBO® shape memory polymer foams developed by Composite Technology Development Inc., in Lafayette, Colo. Foam materials can be machined to produce shaped, high precision trapped tools that can be readily extracted from a finished composite part. The use of extractable tools may provide composite manufacturers with the capability to efficiently produce large, complex composites at costs much lower than with traditional tooling.

Foam extractable tools can enable the cost-effective fabrication of structurally and weight-efficient “unitized” composite structures that include trapped tooling conditions. Trapped tooling can be a challenge because the tool is positioned within a concave structure, under an overhang, etc. Embodiments of the invention provide for a tool that can shrink in a direction transverse to the removal direction. Embodiments of the invention can be attractive to commercial composites manufacturers due to their simplicity of use, attainable precision, robustness, reusability, and cost effectiveness. Embodiments of the invention can also provide an enabling step for the low-cost manufacture of complete aircraft fuselages, walls, wind turbine blades, automotive bodies, etc. in a single manufacturing step.

The use of foam extractable tools can offer many performance benefits over existing extractable tooling technologies, including low cost, high structural stiffness during composite lay-up, and large achievable reductions in volume. Foams can have a high rigidity at temperatures below the glass transition temperature of the foam. Such rigidity can be used to support composite structures during a lay-up process prior to cure. Foams can also be useful because of their high volume change characteristics when subjected to temperatures near or above the glass transition temperature. This volume change can be leveraged to allow for tooling to be extracted from a trapped position.

In some embodiments, a low density, open-celled foam can be produced in blocks and can be precisely machined to complex geometries, similar to conventional tooling materials. These complex geometries can include a trapped configuration. A trapped configuration can include geometries that are the complement or mold of a composite structure that, when formed, traps the tool within the composite structure. These geometries can include overhangs, convex shape or shapes, female portions, trapped shapes, etc.

Foam tooling can be extremely light weight, robust, and can support significant lay-up loads. Once the composite has been cured, the tool can be heated to temperatures near or above the glass transition temperature of the foam, at which point the tool can be deformed as needed for extraction. The foam structure can allow for higher levels of deformation and volume reduction than other types of materials, thereby allowing the tool to be easily extracted from tortuous paths or small openings. Foams, such as shape memory foams (SMP), are capable of precisely recovering their shape and thus can be used repeatedly in the manufacture of composite parts.

### Multiple Use Precision Extractable Tooling

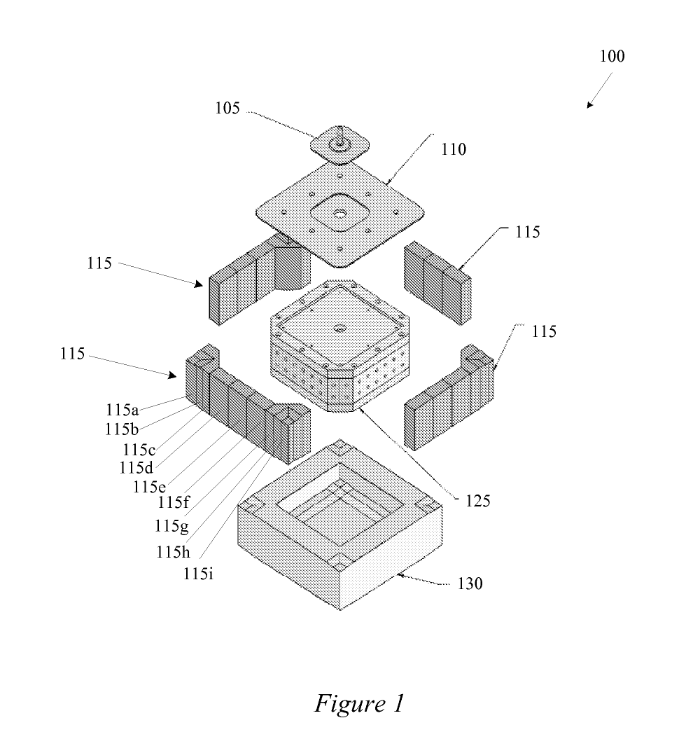

FIG. 1 shows an example of an extractable tool according to some embodiments of the invention. Extractable tool 100 includes a nozzle 105, top plate 110, four foam blocks 115, core 125, and elastic bladder 130. Foam blocks 115 surround core 125. Top plate 110 can be placed over both core 125 and/or foam blocks 115. Top plate 110 can be coupled with nozzle 105 and/or with core 125. Foam blocks 115 can have any unique or intricate external shape. The shape of foam blocks 115, for example, can be complementary to the desired shape of the composite structure being formed. For example, the external shape of foam blocks 115 can be the complement to a trapped shape.

Bladder 130 can be stretched over the outside of the core 125, foam blocks 115, and/or top plate 110. Bladder 130 and nozzle 105 can be sealed together to provide a sealed bladder that surrounds the other components. Bladder 130 can be made from an elastomeric material and/or any material that can accommodate high deformations experienced during tool extraction and/or any elastic material. Bladder 130 can be pressure-tight so that the extractable tool 100 can be pressurized or depressurized during various stages of the composite fabrication process. In some embodiments, a thin, commercially available silicone rubber can be used as the elastic bladder 130. Various other elastic materials can be used. Bladder 130 may also include a thin film coated on the exterior of foam blocks 115 or an integral skin formed during the fabrication of the foam.

Core 125 can be a simple, rigid (non-deformable) component located at the core of extractable tool 100. Several vent holes can be located along core 125 to provide open passages for the flow of air, which can allow extractable tool 100 to be pressurized or evacuated during various stages of the composite fabrication process. Core 125 can include a simple shape and construction, regardless of the complexity of the composite part for which it is intended. The surrounding foam blocks 115 can be machined to accommodate the contours, shapes, and other design features of the composite part. In some embodiments, a standard core 125 can be used for many different applications falling within a general size range.

Foam blocks 115 can be an arrangement of individual foam blocks made from any open celled, low density form. Foam blocks 115 can be produced in blocks and can be precisely machined to complex shapes. Foam blocks 115 can be rigid at ambient temperatures and can be capable of supporting typical lay-up loads without deforming. In some embodiments, foam blocks 115 can have a stiffness to allow for use with typical automatic tape placement and/or automatic fiber placement equipment. Foam blocks 115 can include materials that, when heated to temperatures near or above the glass transition temperature, can become flexible and capable of high levels of deformation and/or volume reduction. This can allow extractable tool 100 to be extracted from tortuous paths, small openings, overhangs, trapped configurations, or the like. In some embodiments, foam blocks 115 can recover its shape when reheated without constraint so that foam blocks 115 can be used repeatedly in the manufacture of multiple composite parts. In some embodiments, a combination of foam blocks and SMP foam blocks can be used.

The corner portions or blocks of extractable tool 100 can have a greater applied force from bladder 130 than other portions of extractable tool 100. To account for this force difference yet allow for uniform compression, the arrangement of foam blocks 115 can have a stiffness profile that varies from foam block to foam block. In some embodiments, foam blocks 115 can include a plurality of foam blocks having different stiffness coefficients. That is, foam blocks 115a-115i can have stiffness coefficients that vary from foam block to foam block. For example, the foam blocks on the corners 115a and 115i can have a stiffness coefficient greater than the foam blocks on the interior 115b-115h. The stiffness coefficient of the next interior blocks 115b and 115h can have stiffness coefficient greater than the stiffness of the remaining interior blocks 115c-115g. The stiffness coefficient of the next interior blocks 115c and 115g can have stiffness coefficients greater than the stiffness coefficients of the remaining interior blocks 115d-115f. The stiffness coefficient of the next interior blocks 115d and 115f can have stiffness coefficients greater than the stiffness coefficients of interior block 115e. Various other arrangements of foam blocks with different stiffness coefficients can be used. Furthermore, various arrangements of foam blocks with different stiffness coefficients can be used for any number of tooling shapes or configurations. In particular, in some configurations, foam blocks that are disposed or located at or near corners of a foam block assembly can have a greater stiffness than other foam blocks.

Nozzle 105 can be coupled with bladder 130 and/or configured to couple with a vacuum pump and/or a compressor to pressurize or depressurize bladder 130. In some embodiments, nozzle 105 can remain accessible throughout lay-up and/or cure processes of the composite part so that the appropriate hardware, such as pressure hoses, can be easily attached and detached as needed. Any type of pressurized nozzle can be used.

Extractable tool 100 can be used with any type of composite structure made from any type of composite materials using any type of process. For example, composite materials can include fiber reinforced polymers, carbon fiber reinforced plastics, glass reinforced plastic, fiber thermoplastics, thermoset composites, etc. Composite materials can be constructed using any type of polymer, for example, epoxy, polyester, vinyl ester, benzoxazine, and/or nylon. In some embodiments, composite materials can be reinforced with various components, for example, Kevlar, aluminum, glass fibers, and/or carbon fibers. Composite forming can include, for example, pre-preg, autoclave molding, co-curing, compression molding, resin infusion, resin transfer molding (RTM), vacuum assisted resin transfer molding (VARTM), SCRIMP, hand lay-up, vacuum bag molding, molding, etc.

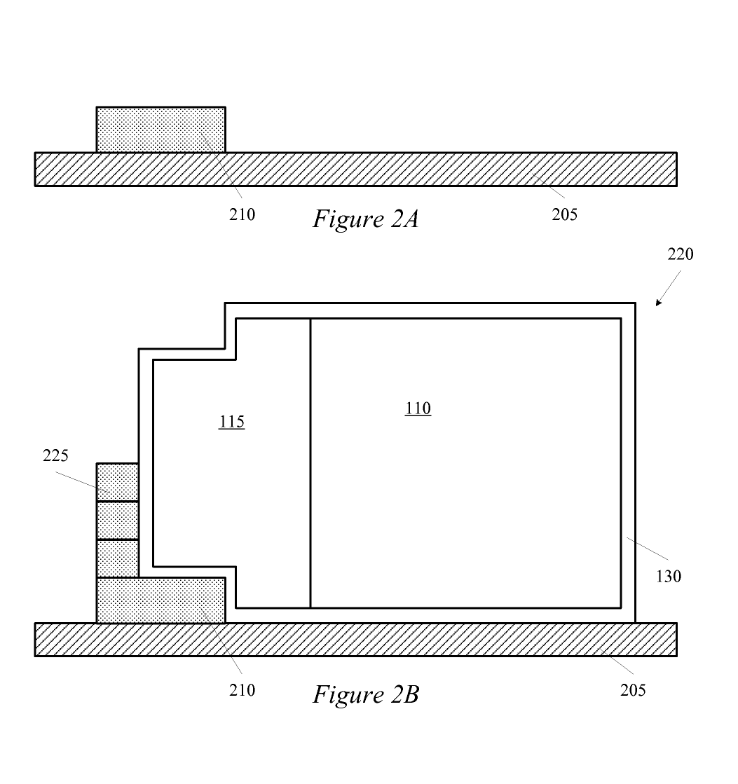

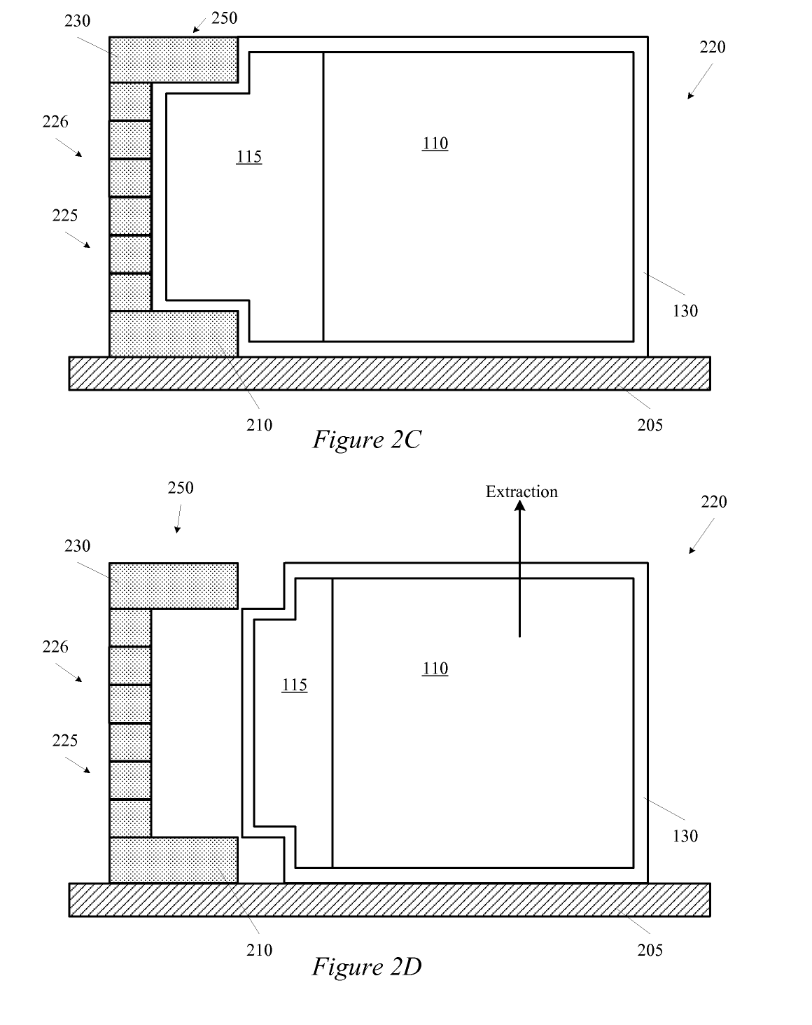

FIG. 2A shows a side view of the beginning of a process for building a composite structure. Layer 210 of composite material can be placed on substrate 205. In FIG. 2B, extractable tool 220 can be placed on substrate 205 and/or partially placed on first layer 210. In some embodiments, extractable tool 220 can be placed on substrate 205 prior to laying up first layer 210. Foam blocks 115 can have any shape such as the complement of the shape of the composite structure being built. Substrate 205 can include any surface. In some embodiments, substrate 205 can be a composite part of a full unitized structure. In other embodiments, substrate 205 can be a tooling device or mold.

FIG. 2B shows three composite layers 225 laid up against extractable tool 220. Foam blocks 115 can provide support to composite layers 225 while being laid up. The shape of foam blocks 115 can be complementary to the desired shape of the composite structure. Thus, foam blocks 115 provide a mold for laying up composite layers. While three composite layers 225 are shown, any number of layers may be used and they may have any thickness.

FIG. 2C shows a side view of composite structure 250 built on substrate 205 against extractable tool 220. As shown, more composite layers 226 have been laid up on composite layers 225. Top layer 230 has also been laid up overhanging extractable tool 220. Composite structure 250 forms a C-shaped structure. The C-shape and/or overhanging top layer 230 can cause extractable tool 220 difficulty in being extracted from the composite structure after manufacturing is complete. That is, composite structure 250 has a shape that traps extractable tool 220.

FIG. 2D shows a side view of composite structure 250 with extractable tool 220 being compressed prior to extraction from being trapped within composite structure 250. After composite structure 250 has been laid up and/or cured, extractable tool 220 may be heated to a temperature near or above the glass transition temperature of foam blocks 115. When foam blocks 115 have been heated above this temperature, they become rubberized. Air within bladder 130 can be evacuated through a nozzle (e.g., nozzle 105 in FIG. 1). The evacuation of air can cause the now rubberized foam blocks 115 to compress. This compression can allow extractable tool 220 to be extracted from being trapped within composite structure 250 as shown in FIG. 2D.

Various trapped-shape structures may require embodiments of the inventions. For example, structures that may have a trapped shape can include I-beams, C-beams, H-beams, double-T-beams, W-beams, rolled steal joists, L-beams, U-beams, etc. Combinations of these beam shapes may also be included. Furthermore, panels with multiple trapped beams, shapes, or configurations may also be present. Embodiments of the invention can be used or adapted for manufacturing of any type of structure with a trapped configuration. Structures may include unitized composite structures that include shells, skins, frames, longerons, stiffeners, beams, and/or other components in various configurations. Unitized composite structures are composite structures made from the same composite material without using fasteners (e.g., screws, bolts, rivets, etc.). Unitized composite structures can include structures with intersecting beams, longerons, and/or stiffeners. Multiple tool devices can be used to create unitized structures.

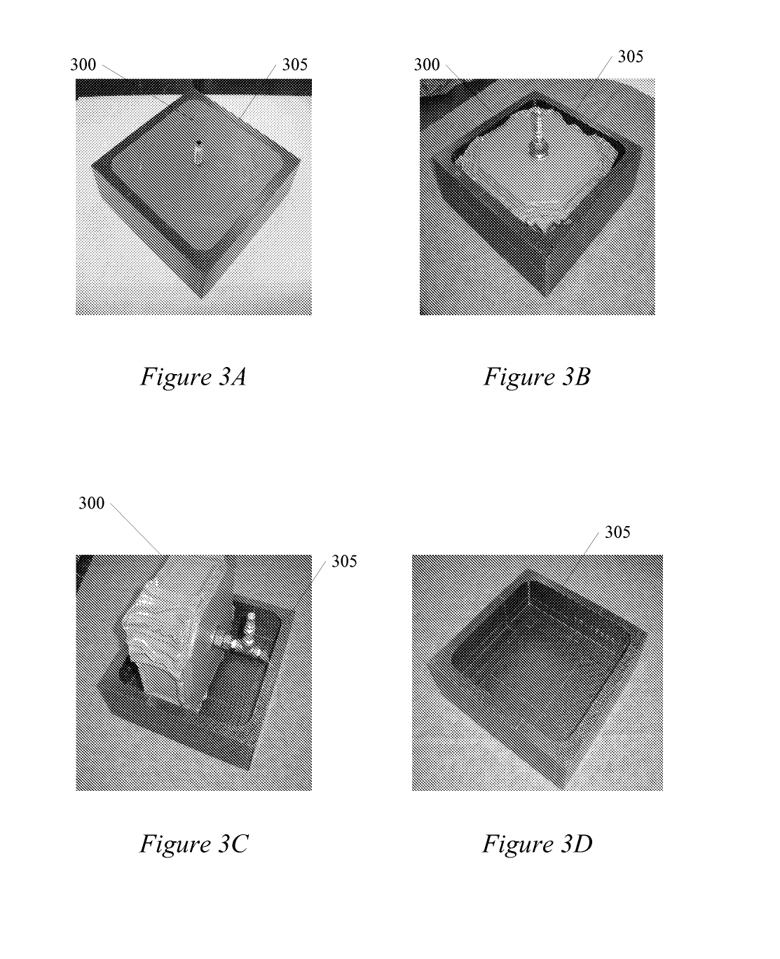

FIG. 3 A shows photographs of tool 300 being extracted from composite structure 305. Composite structure 305 has been laid up around tool 300. After the lay-up process (and possibly curing), tool 300 is trapped within composite structure 305. During cure, positive pressure can be applied within the sealed foam tool, thus applying a consolidation pressure onto the composite laminate during cure much as pressure within an autoclave consolidates composite laminates during cure. That is, the formation of composite structure traps tool 300 with overhangs, concave portions, female portions, etc. Moreover, the composite structure conforms to the shape of the foam within tool 300. FIG. 3B shows tool 300 within composite structure 305 after compression of the foams. For example, tool 300 can become compressed when air is evacuated from tool 300. The compression is due to the foam within tool 300 compressing under vacuum (negative pressure) when heated to temperature near or above the glass transition temperature of the foam.

FIG. 3C shows tool 300 partially removed from within composite structure 305. As shown, once compressed, tool 300 is easily extracted from within the trapped shapes of composite structure 305. FIG. 3D shows composite structure 305 with tool 300 removed.

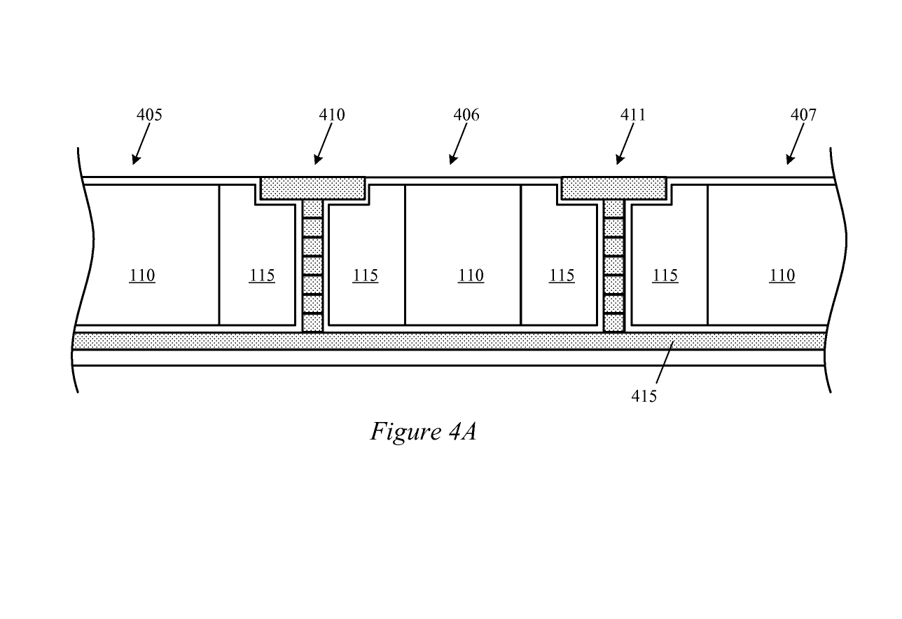

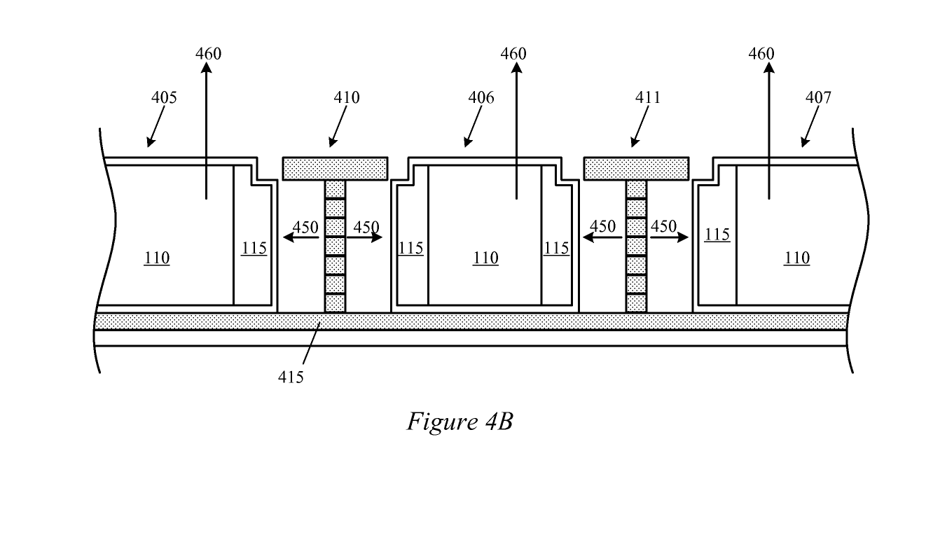

FIG. 4A shows three extractable tools 405, 406, and 407 that have been used to lay-up two composite T-beam structures 410 and 411 according to some embodiments of the invention. Tool 406 can include foam blocks 115 on both sides of core 125 for laying up both T-beams structures 410 and 411. Tools 406 and 407 can also include a plurality of foam blocks that are not shown. Moreover, tools 405, 406, and 407 can be three tools in a multidimensional array of tools being used to manufacture a unitized composite structure. In this embodiment, T-Beams 410 and 411 are laid up directly on skin 415. In this way, skin 415 and T-beams 410 and 411 can be a unitized composite structure. Positive pressure can be applied within the sealed foam tools that can be used to provide for appropriate consolidation of the composite laminates during cure, providing for a high quality composite laminate without use of an autoclave. FIG. 4B shows tools 405, 406, and 407 in a compressed state. After compression, tools 405, 406, and 407 can be extracted. As shown, the direction of compression of foams 450 can be transverse to the direction of extraction 460.

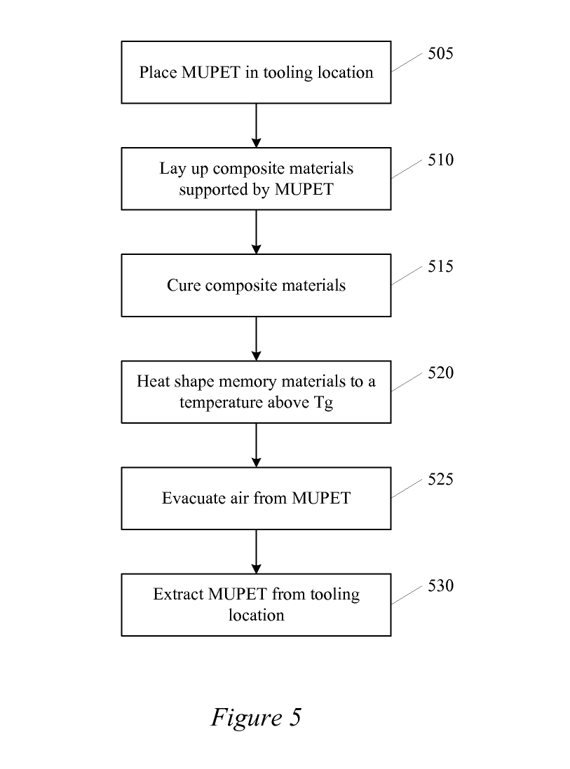

FIG. 5 is a flowchart of process 500 for using a tool according to some embodiments of the invention. At block 505, an extractable tool (e.g., tool 405, 406, 407, 300, 220, or 100) can be placed in a tooling location. This extraction tool can include foam(s) with various shapes and/or contours that are complementary to the shape of the structure being developed. A positive pressure can be applied within the tool to provide consolidation for the composite laminate.

At block 510 composite materials are laid up on or supported by portions of the extraction tool. In some embodiments, a positive pressure can be applied by the extraction tool during lay up. Composite materials can be laid up using any number of manufacturing techniques known in the art. A plurality of layers can be laid up in order to form the composite structure. In some embodiments, composite materials can be laid up in a configuration that traps the tool within the composite structure. In some embodiments, composite materials can form a concave, and/or overhanging shape trapping the extraction tool. At block 515 the composite materials can be cured.

At block 520 the tool can be heated to a temperature near or above the glass transition temperature of the foam within the extraction tool. Once the foam has reached temperature, air can be evacuated from the extraction tool, causing compression of the foam at block 525. Once compression has occurred at a level sufficient to allow the tool to be removed from being trapped by the composite structure, the extraction tool can be removed at block 530.

### Reflectors

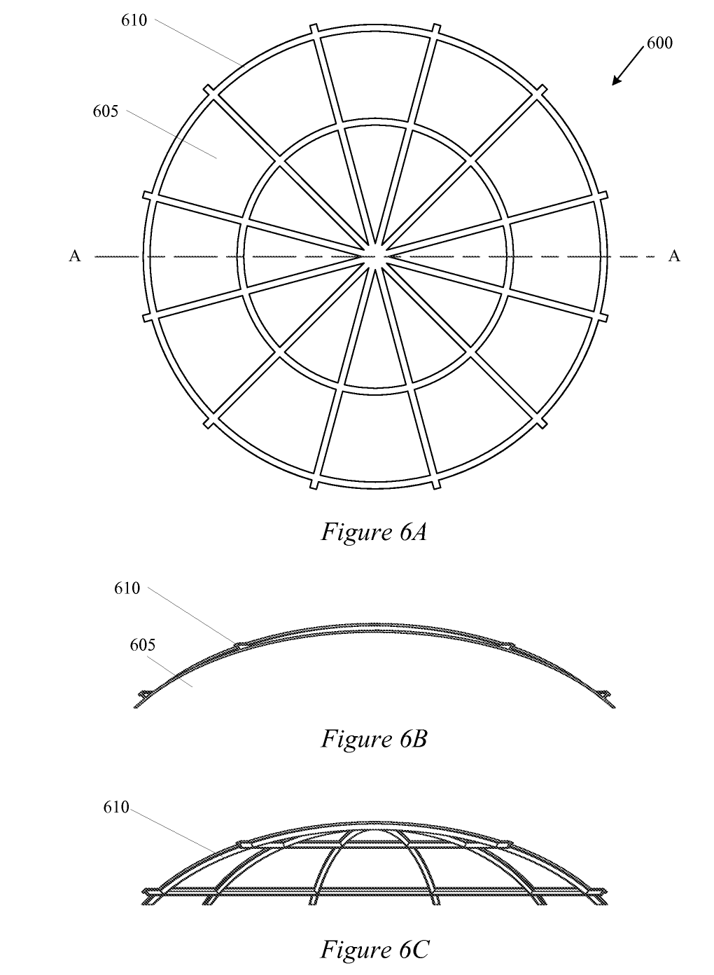

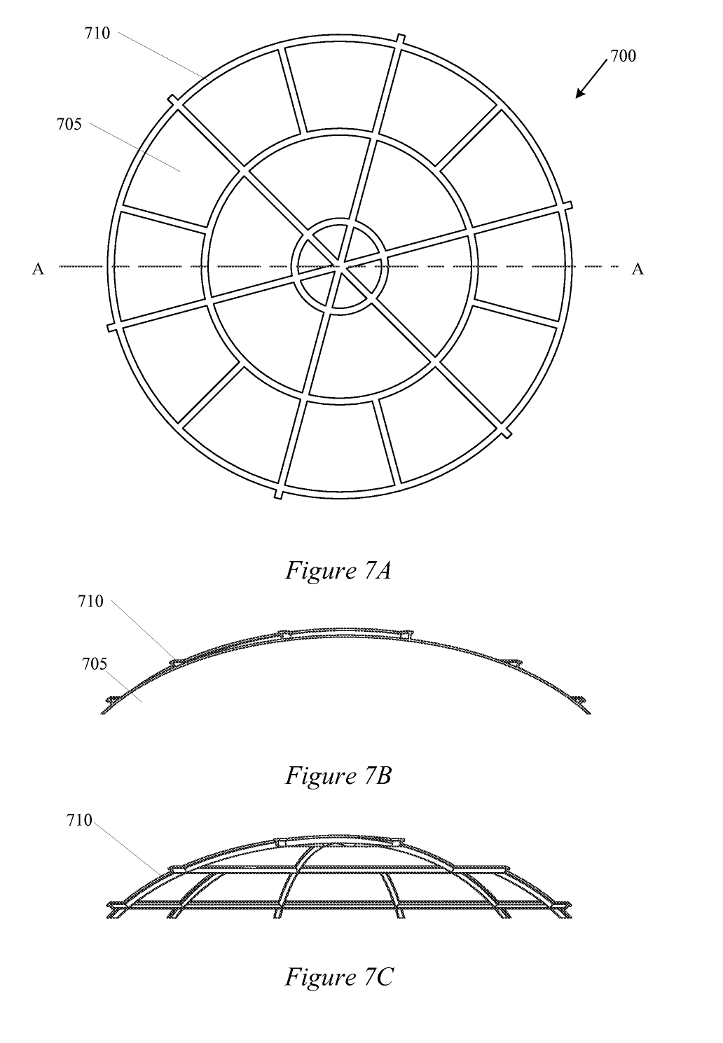

FIG. 6A shows the back view of reflector system 600 according to some embodiments of the invention. Reflector system 600 includes reflector 605 and support structure 610. Support structure 610 includes a plurality of elements extending outwardly from the center of reflector 605 and two elements forming concentric circles centered around the center of reflector 605. The number and/or configuration of the elements within the support structure can vary. As shown in the figure, support structure 610 is formed on the back surface of reflector 605.

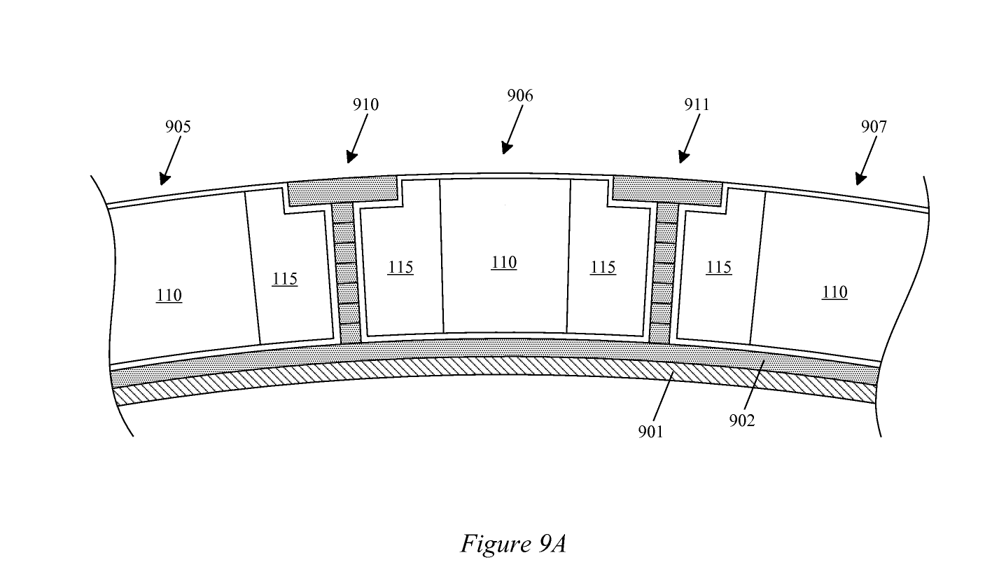

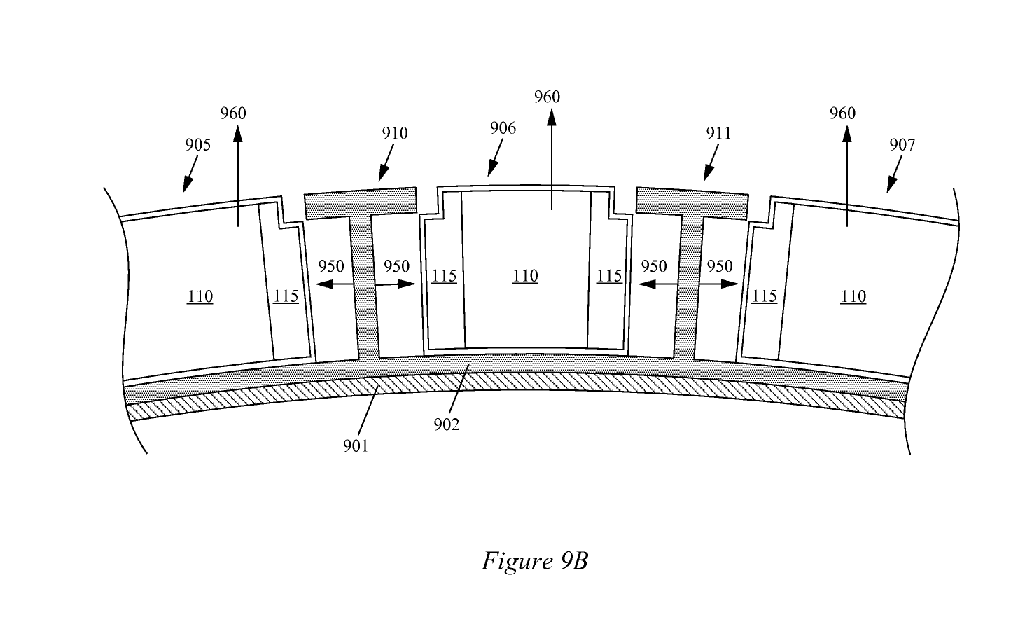

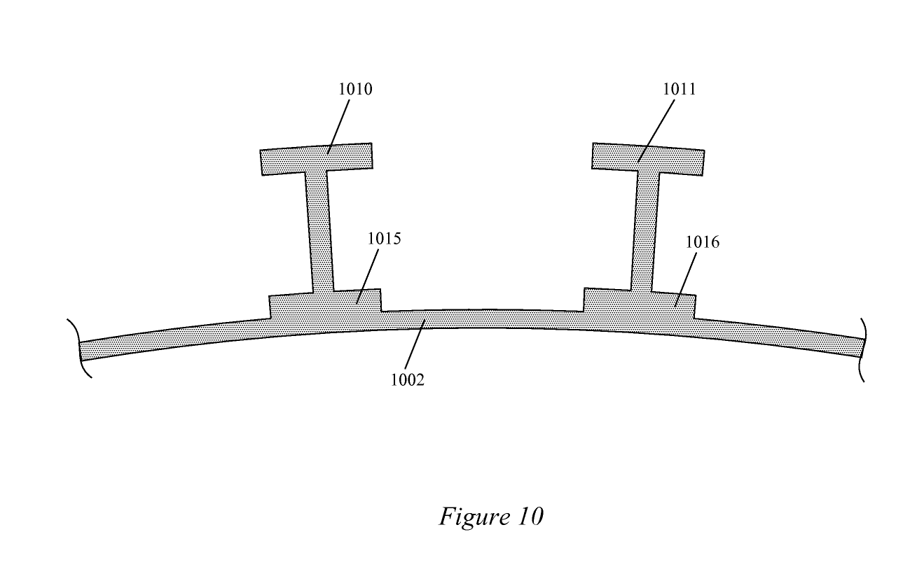

FIG. 6B shows a side view of reflector system 600 cut along section A-A in FIG. 6A. Note that reflector 605 and support structure 610 comprise a unitary structure. That is, support structure 610 and reflector 605 are not coupled together with fasteners or glues. Instead, support structure 610 and reflector 605 can be formed together in manufacturing process. For example, reflector 605 and support structure 610 can be laid up using the same or similar materials. Moreover, support structure elements can include I-beam shaped elements. In some embodiments, the reflector can comprise the bottom of the two horizontal bars that make up the “I” shaped structure of an I-beam (see FIGS. 9A and 9B). In other embodiments, the bottom of the two horizontal bars can be included in addition to the reflector (see FIG. 10). The I-beam configuration of support structure elements provides trapped tooling situations, which can be solved using embodiments of the invention.

FIG. 6C shows a side view of reflector system 600 cut along section A-A in FIG. 6A but without reflector 605. This figure is provided to show the three dimensional arrangement of the elements within support structure 610.

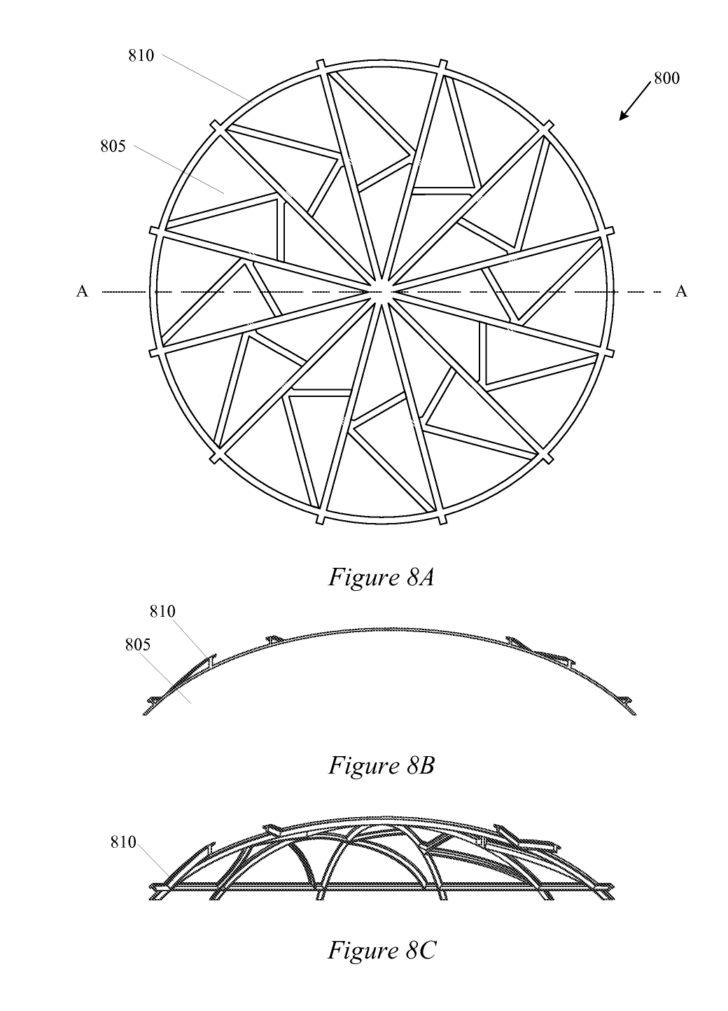

FIG. 7A shows the back view of reflector system 700 according to some embodiments of the invention. Reflector system 700 includes reflector 705 and support structure 710. Support structure 710 includes a plurality of structure elements extending outwardly from the center of reflector 705 and two elements forming concentric circles centered around the center of reflector 705. Another plurality of structure elements extend between the concentric circles. As shown in the figure, support structure 710 is formed on the back surface of reflector 705.

The number and/or configuration of the elements within the support structure can vary. FIG. 7B shows a side view of reflector system 700 cut along section A-A in FIG. 7A. FIG. 7C shows a side view of reflector system 700 cut along section A-A in FIG. 7A but without reflector 705.

FIG. 8A shows the back view of reflector system 800 according to some embodiments of the invention. Reflector system 800 includes reflector 805 and support structure 810. Support structure 810 includes a plurality of elements extending outwardly from the center of reflector 805 and two elements forming concentric circles centered around the center of reflector 805. As shown in the figure, support structure 810 is formed on the back surface of reflector 805.

The number and/or configuration of the elements within the support structure can vary. FIG. 8B shows a side view of reflector system 800 cut along section A-A in FIG. 8A. FIG. 8C shows a side view of reflector system 800 cut along section A-A in FIG. 8A but without reflector 805.

Reflector systems 600, 700 and 800 are provided to show that various support structure configurations can be used. Various other configurations can also be used.

FIG. 9A shows three extractable tools 905, 906, and 907 that have been used to lay-up two composite I-beams 910 and 911 with reflector 902 according to some embodiments of the invention. Tool 906 can include foam blocks 115 on both sides of core 125 for laying up both I-beams 910 and 911. Tools 906 and 907 can also include a plurality of foam blocks that are not shown. Moreover, tools 905, 906, and 907 can be three tools in a multidimensional array of tools being used to manufacture a unitized composite structure.

In this embodiment, I-Beams 910 and 911 are laid up directly on reflector 902. Prior to laying up I-Beams 910 and 911, reflector 902 can be laid up on form 901. In this way, reflector 902 and I-beams 910 and 911 can be a unitized composite structure. Form 901 can include the proper shape for reflector 902 to be laid up. For example, form 901 can take have a parabolic or spherical shape.

Positive pressure can be applied within sealed foam tools, which can provide for appropriate consolidation of the composite laminates during cure. This can provide a high quality composite laminate without use of an autoclave. FIG. 9B shows I-beams 910 and 911 with reflector 902 as a unitary structure. In this figure tools 905, 906, and 907 are in a compressed state. After compression, tools 905, 906, and 907 can be extracted. As shown, the direction of compression of foams 950 can be transverse to the direction of extraction 960.

In FIGS. 9A and 9B any type of laminate formation technique can be used to form the reflector and/or the support structure. For example, the laminate formation technique can include pre-preg, autoclave molding, co-curing, compression molding, resin infusion, resin transfer molding (RTM), vacuum assisted resin transfer molding (VARTM), SCRIMP, hand lay-up, vacuum bag molding, molding, etc

After extraction, the tool can be allowed to return to its original shape and/or configuration. This can be done, for example, by releasing the vacuum pressure from within the extraction tool bladder. Because of the flexibility and potential for volume change of foams and/or shape memory qualities of foams and/or SMP foams, the extraction tool can return to the original shape after being heated and depressurized. The extraction tool can then be reused as a mold for another composite structure.

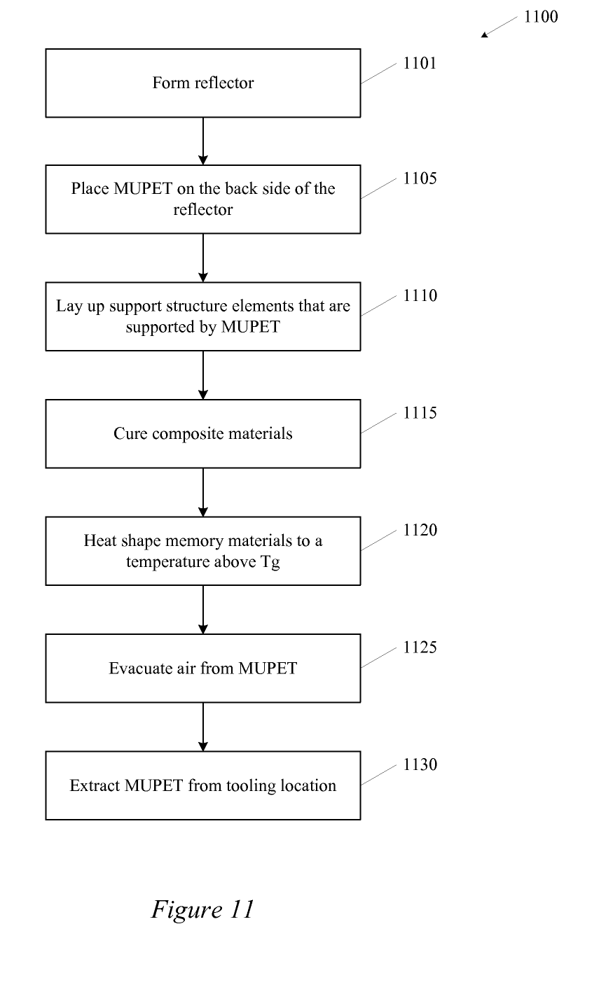

FIG. 10 shows a side view of a portion of reflector 1002 and I-beam support structures 1010, 1011 according to some embodiments of the invention. In this embodiment, bottom horizontal bars 1015, 1016 of the I-beam, while integral with reflector 1002, they are laid up on the back side of reflector 1002. The reflector systems shown in FIGS. 6-10 can be formed following the process outlined in FIG. 11.

FIG. 11 is a flowchart of process 1100 for using a tool according to some embodiments of the invention. At block 1101 the reflector can be formed. The reflector can be formed by laying up composite layers on a form (e.g., form 901) that has the require reflector shape. The reflector can be formed using any type of composite material and/or using any type of composite forming method.

At block 1105, an extractable tool (e.g., tool 405, 406, 407, 300, 220, or 100) can be placed in a tooling location on the back surface of reflector. This extraction tool can include foam(s) with various shapes and/or contours that are complementary to the shape of the structure being developed. A positive pressure can be applied within the tool to provide consolidation for the composite laminate.

At block 1110 composite materials are laid up on or supported by portions of the extraction tool to form the support structure. In some embodiments, a positive pressure can be applied by the extraction tool during lay up. Composite materials can be laid up using any number of composite forming techniques known in the art. A plurality of layers can be laid up on the reflector surface in any number of shapes and/or configurations in order to form the support structure. In some embodiments, composite materials can be laid up in a configuration that traps the tool within the composite structure. In some embodiments, composite materials can form a concave, and/or overhanging shape trapping the extraction tool. At block 1115 the composite materials can be cured.

At block 1120 the tool can be heated to a temperature near or above the glass transition temperature of the foam within the extraction tool. Once the foam has reached temperature, air can be evacuated from the extraction tool, causing compression of the foam at block 1125. Once compression has occurred at a level sufficient to allow the tool to be removed from being trapped by the composite structure, the extraction tool can be removed at block 1130.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

Rapid Cycle MUPET

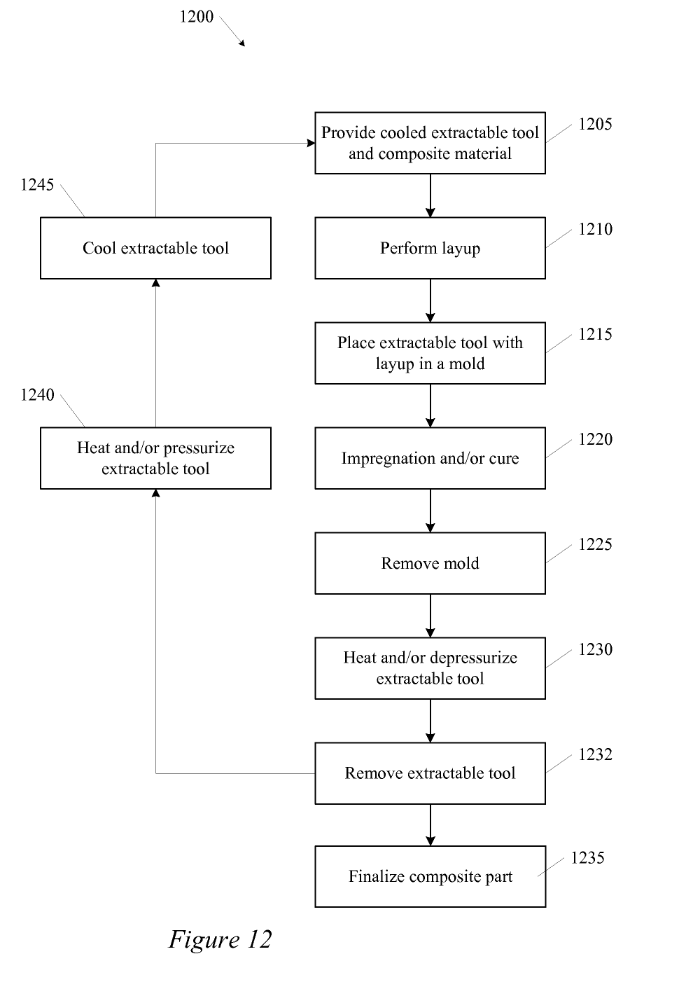

FIG. 12 shows rapid cycle MUPET process 1200 according to some embodiments of the invention. At block 1205, an extractable tool and fiber sheet(s) are provided. The extractable tool can include various shapes and sizes depending on the specific application. Moreover, the extractable tool can include a nozzle, top plates, foam blocks, a core, and an elastic bladder, for example, like the extractable tools described above (e.g., extractable tool 105). The foams in extractable tool can include shape memory polymer foams or non-shape memory polymer foams. Various other components can be included. The fiber sheet can include any type of fiber sheet including, for example, carbon fibers, glass fibers, aramid fibers, nylon fibers, and thermoplastic fibers, etc. These fibers can be woven fibers, non-woven fibers, uni-directional fibers, braided fibers, chopped fibers, fibers mixed with particulate fillers, etc. The extractable tool can have a complex or simple three dimensional shape. In some configurations, the extractable tool can have the compliment of a trapped shape. At block 1205, the extractable tool can have a positive pressure to provide consolidation for the fiber sheet during layup and cure.

At block 1210 the fiber sheet(s) can be laid up on and/or around the extractable tool. For example, the fiber sheet(s) can be wrapped around portions of the extractable tool. A single fiber sheet or many fiber sheets may be laid up. The fiber sheet may be placed on or around multiple surfaces, faces, or dimensionally distinct areas of the extractable tool.

At block 1215 the fiber sheet and the extractable tool can be placed within a mold. The mold can provide a number of benefits. The mold can provide a second surface that the fiber sheet conforms to. That is, the fiber sheet can be pressed between the mold and the extractable tool. Both the mold and the extractable tool can have shapes that mold the shape of the fiber sheet into the desired shape. The mold can also provide one or more impregnation injection points. That is, resin can be injected into the fiber sheet through one or more impregnation points within the mold. Multiple impregnation points can allow for decreased impregnation times and/or for use of viscous resins. The resin can be injected into the mold and/or fiber sheet under pressure. Impregnation points can be strategically located close together or far apart, for example, depending on the curvature or shape of the mold.

After and/or in conjunction with impregnation the resin can be cured by heating the resin, fiber sheet, mold, and/or extractable tool at or above the cure temperature. During impregnation and/or cure the extractable tool and/or mold can apply a pressure on the fiber sheet.

After the resin has cured, the mold can be removed at block 1225. At block 1230, the extractable tool can be heated to a temperature above the glass transition temperature of the foams within the extractable tool and the extractable tool can be depressurized to a pressure below atmospheric pressure (e.g., vacuum pressure). The combination of the heat and the applied vacuum can cause the extractable tool to shrink in size allowing the extractable tool to be extracted from the composite structure at block 1232. Because the extractable tool shrinks in size, the extractable tool can be removed from within a trapped configuration formed by the now composite structure (cured fabric sheets and resin). At block 1235 the composite structure can undergo further fabrication such as trimming, drilling, shaping, and/or assembly.

At block 1240, the extractable tool can be heated (e.g., above the glass transition temperature of the foam) and pressurized to return to the extractable tool to the original shape or the tooling shape. Moreover, the tooling shape can be the original shape that the foam returns to when heated above the glass transition temperature, which is also the shape of the extractable tool during layup. After heating and/or pressurization, the extractable tool can be cooled at block 1245. Process 1200 can then return to block 1205 and the extractable tool can be used to form another composite structure.

Process 1200 can be used with multiple extractable tools. For example, a first extractable tool can be used for blocks 1205-1230 while a second extractable tool is simultaneously used in blocks 1240 and 1245. After the first iteration the first extractable tool can be used in the process in blocks 1240 and 1245 while the second extractable tool is used in the processes in blocks 1205-1230.

As another example, three extractable tools can be used. That is while a first tool is being heated and/or pressurized in block 1240, a second tool can be cooled in block 1245, and a third tool can be used in blocks 1205-1230. The three extractable tools can rotate through the various blocks during subsequent iterations.

As yet another example, any number of extractable tools can be used. That is, two or more extractable tools may be used in blocks 1240 and/or 1245 while a single tool is used in blocks 1205-1230. The various extractable tools can then be rotated through the various blocks during subsequent iterations. During operation, multiple extractable tools can be used in blocks 1240 and/or 1245.

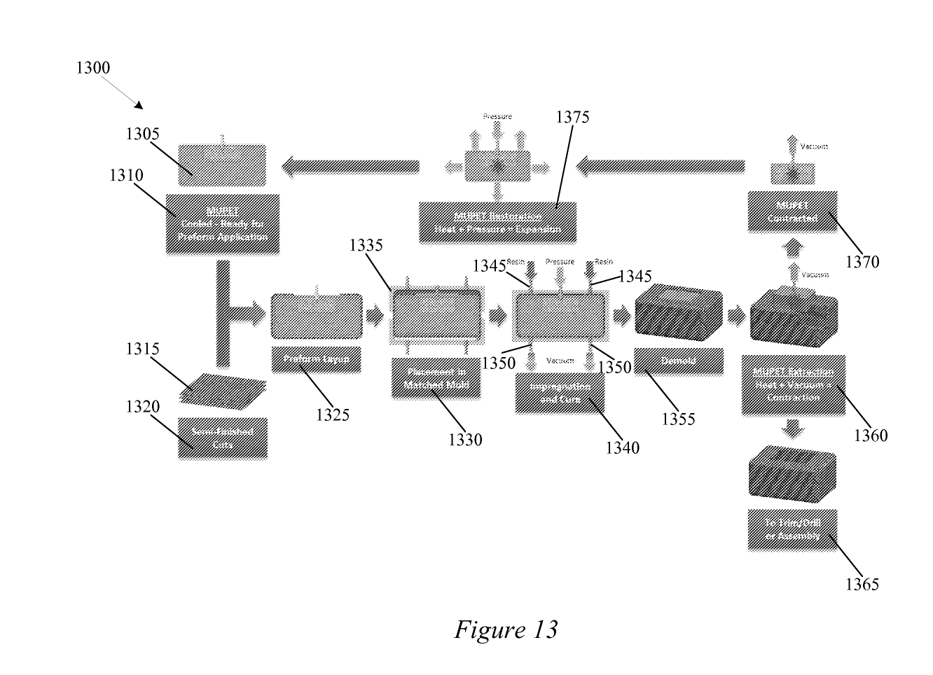

FIG. 13 shows process 1300 that is similar to the process shown in FIG. 12. Extractable tool 1305 (e.g., MUPET or extractable tool 100) at block 1310 is cooled and ready for pre-form application. Fiber sheet(s) 1310 is cut and ready for application at block 1320. At block 1325 fiber sheet(s) 1315 are conformed to extractable tool 1305. At block 1330, fiber sheet(s) 1310 and the extractable tool 1305 are placed in mold 1335. Mold 1335 can be secured around the sheets of fiber sheet(s) 1315.

At block 1340, fiber sheet(s) 1315 can be impregnated with resin and/or cured. During impregnation and/or cure, extractable tool 1305 can be pressurized. Moreover, the cure temperature can be below the glass transition temperature of the foam comprising extractable tool 1305. Resin can be placed into the fiber sheet through ports 1345 in mold 1335. A vacuum can be pulled through ports 1350 while the resin is being introduced through other ports 1345.

At block 1355, mold 1335 can be removed. At block 1360, extractable tool 1305 can be heated and pressurized causing a decrease in volume, which can allow extractable tool 1305 to be extracted from the now cured composite structure as shown at block 1370. At block 1365, the composite structure can undergo further processing. At block 1375, the extractable tool can be heated and/or pressurized, which can allow the tool to return to its original shape and used again starting at block 1310.

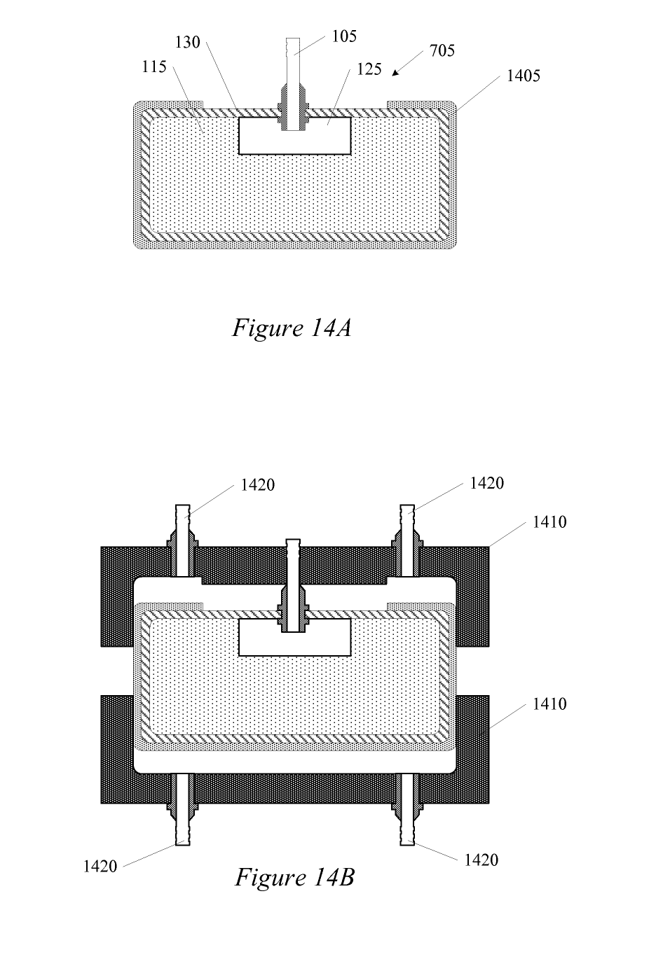

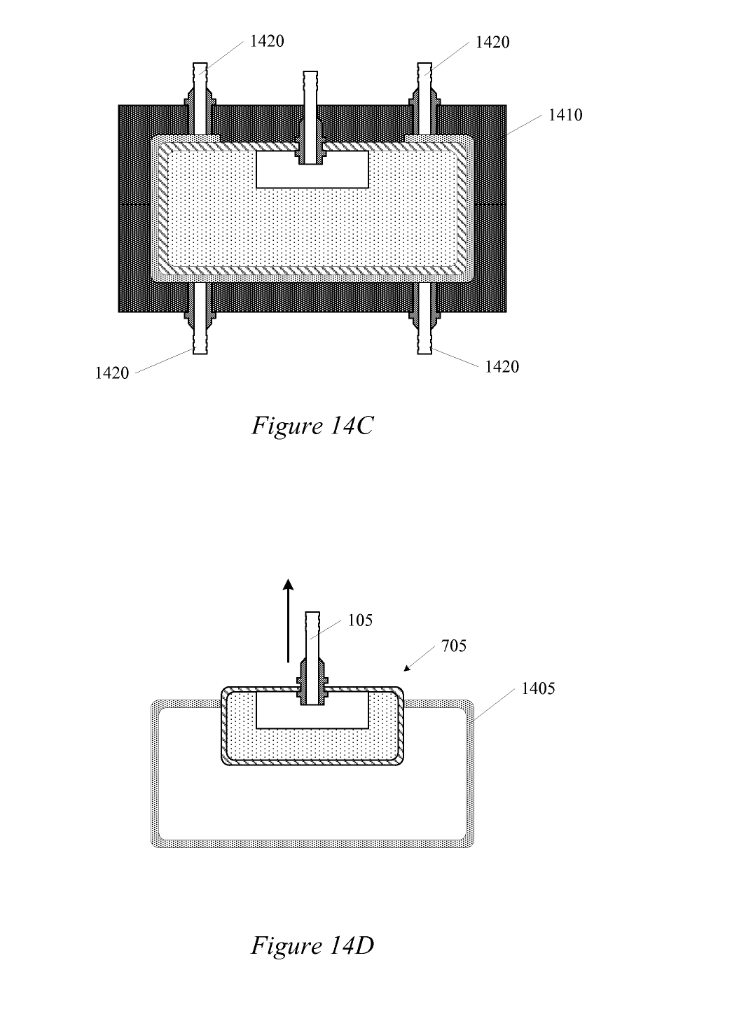

FIG. 14A shows a side view of extractable tool 1305 that includes a nozzle 105, foam blocks 115, core 125, and elastic bladder 130. Fabric sheet 1405 can be wrapped and/or laid up around foam blocks 115 (see e.g., block 1210 of figure 12 and/or block 1325 of figure 13). In this state foam blocks 115 can be in their original state and/or at a temperature much lower than the glass transition temperature of the foam.

FIG. 14B shows mold 1410 placed around fiber sheet 1405 and extractable tool 1305 (see e.g., block 1215 in FIG. 12 and block 1330 in FIG. 13). Mold 1410 and/or extractable tool 1305 can comprise any three-dimensional shape. In the figure mold 1410 comprises a top portion and a bottom portion. The two portions can be joined together to conform composite sheet between mold 1410 and extractable tool 100. Certainly, mold 1410 can include any number of components or portions that can be conjoined or combined around fiber sheet 1405 and/or extractable tool 1305. Mold 1410 can include a number of ports 1420 that can be used to control the pressure within the mold and/or to impregnate a resin into the fiber sheet and/or mold.

As shown in FIG. 14C the upper and lower portions of mold 1410 can be conjoined. For example, the upper and lower portions of mold 1410 can be sealed together, which can be useful when impregnating fiber sheet 1405 with resin. Fiber sheet 1405 can be impregnated with resin by introducing it into the mold through one or more ports 1420. During impregnation, the extractable tool 1305 may be pressurized through nozzle 105 (see e.g., block 1220 of FIG. 12 and/or block 1340 of FIG. 13). In some embodiments, resin can be introduced through a portion of the ports 1420 while a vacuum is being pulled through the other ports 1420. Resin, for example, can be introduced through the upper ports while a vacuum is being pulled in the lower ports. In this way, the resin is pulled through fiber sheet 1405 into the entire fiber sheet. Ports 1420 can be positioned in various locations around mold 1410. The resin can be, for example, a rapid cure resin.

Once the resin has impregnated fiber sheet(s) 1405, the resin and fiber sheet can be cured by heating the fiber sheet and the resin to a temperature above a cure temperature for a period of time (the cure time). The temperature and the cure time, for example, can depend on the size of the fiber sheet, the type of resin, the type of fiber, the thickness of the fiber, etc. Ideally, the cure time is less than 20, 15, 12, 10, 8, 5, 3, or 2 minutes. Furthermore, once the resin is impregnated and prior to the thermal cure step, a consolidation pressure in excess of atmospheric pressure can be added internally to the extractable tool 1305 thus consolidating the impregnated fibers to the desired thickness and fiber volume fraction. This consolidation pressure is reacted against mold 1410.

After impregnation and cure, the composite structure is formed. Mold 1410 can be removed (see e.g., block 1225 of FIG. 12 and/or block 1355 of FIG. 13). Prior to removal of mold 1410 the consolidation pressure can be relieved from extractable tool 1305. The extractable tool 1305 can be heated to a temperature above the glass transition temperature of the foam and depressurized to vacuum pressure (below atmospheric pressure). This heating and low pressure can shrink the size of extractable tool 1305 by compressing foam 115 and allowing extractable tool to be removed as shown in FIG. 14D (see e.g., block 1230 of FIG. 12 and/or block 1360 of FIG. 13). Once extractable tool 1305 is removed, a composite structure with a trapped shape remains.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1.-42. (canceled)

43. A tooling device comprising:
a rigid core;
a foam block disposed next to the core and comprising a shape; and
a bladder surrounding the core and the foam block, wherein the bladder forms a barrier between an external environment and the core and the foam block.

44. The tooling device according to claim 43, wherein the foam block comprises a foam assembly including a plurality of foam blocks with a variety of different stiffness coefficients.

45. The tooling device according to claim 44, wherein the plurality of foam blocks are disposed next to or around the core.

46. The tooling device according to claim 43, wherein the foam block comprises a shape memory polymer, wherein the foam block is deformable at temperatures near or above a glass transition temperature.

47. The tooling device according to claim 43, wherein the shape of the foam block comprises a shape that is the compliment of a trapped shape.

48. The tooling device according to claim 43, wherein the foam block is stiff at temperatures below the glass transition temperature of the foam block.

49. The tooling device according to claim 43, further comprising a nozzle coupled with the bladder.

50. The tooling device according to claim 43, wherein the nozzle and the bladder form a pressure barrier between the external environment and the core and the foam block.

51. The tooling device according to claim 43, wherein the core comprises a plurality of vent holes that provide passage for air.

52. The tooling device according to claim 43, wherein the stiffness of the foam block at room temperature comprises a stiffness to allow for use with an automatic tape placement device, vacuum assisted resin transfer molding processes, hand lay up processes, filament winding processes, or an automatic fiber placement device.

53. The tooling device according to claim 43, wherein the bladder comprises a thin membrane and/or a silicon membrane.

54. A method for forming a composite structure, the method comprising:
positioning a tooling device in a workspace, wherein the tooling device comprises a foam material;
laying-up composite layers that are supported by the foam material;
curing the composite layers;
applying positive consolidation pressure in the mold during cure;
heating the foam material to a temperature near or above the glass transition temperature of the foam material; compressing the foam material; and
extracting the tooling device.

55. The method for forming a composite structure according to claim 54, wherein the foam material comprises a shape memory polymer foam.

56. The method for forming a composite structure according to claim 54, wherein the foam material is surrounded by a membrane that can be pressurized or evacuated allowing for consolidation of the composite laminate and compression of the foam.

57. The method for forming a composite structure according to claim 56, further comprising pressurizing with air or evacuating air from the tooling device.

58. The method for forming a composite structure according to claim 56, wherein positive pressure is applied that provides consolidation pressure on the composite laminate during cure.

59. The method for forming a composite structure according to claim 54, wherein the tooling device is compressed in a direction that is transverse to the direction the tooling device is extracted.

60. A tooling device comprising:
a solid core; and
a collapsible assembly surrounding portions of the solid core, wherein the collapsible assembly can be used to mold composites structures that have a trapped shape.

61. The tooling device according to claim 60, wherein the collapsible assembly comprises a shape memory polymer foam.

62. The tooling device according to claim 60, wherein the collapsible assembly is deformable at temperatures near or above a glass transition temperature.
